(19) United States
(12) Patent Application Publication
(10) Pub. No.: US 2009/0000412 A1
(43) Pub. Date: Jan. 1, 2009

(54) Angled drive device

(75) Inventor: Joseph R. March, Charlton, MA (US)

Correspondence Address: LAHIVE & COCKFIELD, LLP;FLOOR 30, SUITE 3000, ONE POST OFFICE SQUARE, BOSTON, MA, 02109, US

(73) Assignee: Lutco, Inc., Worcester, MA (US)

(21) Appl. No.: 11/823,627

(22) Filed: Jun. 28, 2007

(51) Int. Cl. F16H 1/12

(52) U.S. Cl. 74/416

(57) ABSTRACT

An angled drive device transforms rotational motion about one axis into rotation motion about a second non-parallel axis, wherein the inner workings of the angled drive device are substantially formed using the inner races of bearings. By incorporating multiple components of the exemplary angled device drive into inner races of the support bearings, the costs of manufacturing the angled drive device can be reduced, the angled drive device can be more reliable, and the angled drive device is more compact, allowing it to function in situations with fixed space constraints.

### FIELD OF THE INVENTION

The present invention relates to an angled drive for converting rotational motion about one axis into rotation motion about a second non-parallel axis using gears and bearings. The present invention is more particularly related to the provision of an angled drive mechanism wherein the inner workings are substantially formed using the inner races of bearings.

### BACKGROUND OF THE INVENTION

In the row planting industry chain and sprocket assemblies are commonly used to drive seed metering or similar devices. However, chain and sprocket assemblies require substantial maintenance, experience degraded performance with wear over time, and are vulnerable to failure due to debris interfering with the sprocket and chain. It is difficult to maintain sufficient lubrication of all of the components of a chain over time. The spacing of links in a chain also increases over time due to wear at pivot points. This increased link spacing creates a mismatch between the chain link spacing and tooth spacing of the corresponding sprockets, greatly increasing the rate of wear of the sprockets. Chain wear greatly affects seed spacing when used in seed metering devices. The “loosened” chain also leads to accelerated wear on the sprockets and premature failure of the assembly. Additionally, if a chain and sprocket assembly is not completely enclosed, “field trash” substances like dirt, mud, and plant matter can stick to the chain interfering with the operation of the assembly and causing the chain to jump off of the sprocket.

A possible replacement for a chain and sprocket assembly is a system of two or more right angle drives. A common right angle drive is a bevel gear assembly with two bevel gears mounted on shafts at right angles to each other and meshing. However, bevel gears are expensive to manufacture because they require a precision assembly. The bevels in the bevel gear assembly exert a thrust load on the assembly which is detrimental.

### SUMMARY

A need exists for dependable, low cost and low maintenance angled drive devices to replace a chain and sprocket system that are sufficiently compact to fit the space requirements of existing row planting machinery. The present invention is directed toward further solutions to address this need, in addition to having other desirable characteristics.

In accordance with one example embodiment of the present invention, an angled drive device includes a first inner race having a first end and a second end, a first outer race disposed about the first inner race to form a first support bearing and a second outer race disposed about the first inner race to form a second support bearing. The first inner race includes a driver disposed within the first inner race, and a first gear disposed between the first and second ends of the first inner race and positioned between the first and second support bearings. The angled drive device also includes a second inner race having a first end and a second end. A third outer race is disposed about the second inner race to form a third support bearing. The second inner race includes a second gear coupled with the second inner race at the first end and a coupling disposed at the second end. The first gear and the second gear are configured to mesh at a predetermined shaft angle to form the angled drive device.

In accordance with aspects of the present invention, the angled drive device can also include a shaft coupled with the second inner race and coupled with the second gear. The second gear can be formed integral with the shaft. The second gear can be formed integral with the second inner race. The predetermined shaft angle can be between about 45 degrees and about 90 degrees. The predetermined shaft angle can be substantially 90 degrees.

In accordance with further variations of the present invention, the first gear can include an inner cylindrical ring member and a disc member integral with the inner cylindrical ring member and having a plurality of tooth protrusions. Each of the plurality of tooth protrusions can have a rounded profile when viewed radially. A width of the rounded profile of each tooth protrusion can become smaller as a distance from an axis of the first gear decreases. A shape of each tooth protrusion and a width of the rounded profile of each tooth protrusion can enable line contact when meshing. The first gear can be a formed gear, a stamped gear or a machined gear.

In accordance with other variations of the present invention, the second gear can include a cylindrical base with a first face and a raised gear portion protruding from the first face of the cylindrical base and integral with the cylindrical base. The raised gear portion can include a plurality of teeth. A profile of each tooth can be substantially “U” shaped when viewed axially, and each tooth can taper along an axial profile enabling line contact when meshing. The second gear can be in the form of a modified spur gear.

In accordance with still other variations of the present invention, the angled drive device can also include a housing coupled with the first support bearing, the second support bearing and the third support bearing. The angled drive device can also include a mounting flange coupled with the first inner race. The angled drive device can include a locking engagement mechanism for engaging and disengaging from a drive system.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of an angled drive device, according to one embodiment of the present invention;

FIG. 2A is a diagrammatic illustration of portions of the angled drive device showing a predetermined shaft angle and meshing of a first gear with a second gear, according to aspects of the present invention;

FIG. 2B is a diagrammatic illustration of portions of the angled drive device from a second perspective that shows a decreasing width of a rounded profile of each tooth protrusion as a distance from an axis of the first gear decreases, and that shows the taper of each tooth of the second gear along the axial profile that enable line contact when the gears mesh, according to aspects of the present invention;

FIG. 2C is a diagrammatic illustration of portions of the angled drive device from a third perspective viewing the first gear from a radial direction and viewing the second gear from an axial direction, according to aspects of the present invention;

FIG. 3 is a diagrammatic illustration of an axial view of a portion of the first gear depicted in FIGS. 2A to 2C, according to aspects of the present invention;

FIG. 4A is a diagrammatic illustration of another embodiment of an angled drive device of the present invention including a locking engagement mechanism that is engaged with a drive system; and

FIG. 4B is a diagrammatic illustration of the embodiment of FIG. 4A when the angled drive device is disengaged from a drive system.

### DETAILED DESCRIPTION

An illustrative embodiment of the present invention relates to an angled drive device design that is dependable, low cost, and low maintenance, as well as compact. An illustrative embodiment incorporates the inner workings of the angled drive device into inner races of support bearings. An illustrative angled drive device includes a first inner race incorporating a drive and a first gear, and a first outer race and a second outer race both disposed about the first inner race forming a first support bearing and second support bearing. The illustrative angled drive device also includes a second inner race incorporating a second gear and a coupling, and a third outer race disposed about the second inner race to form a third support bearing. The two gears are configured to mesh at a predetermined shaft angle forming the angled device drive. By incorporating multiple components of the angled device drive into the first and second inner races of the support bearings, the costs of manufacturing the angled drive device are reduced, the angled drive device is more reliable, and the angled drive device is more compact, allowing it to function in situations with fixed space constraints. The present invention is directed toward further solutions to address this need, in addition to having other desirable characteristics.

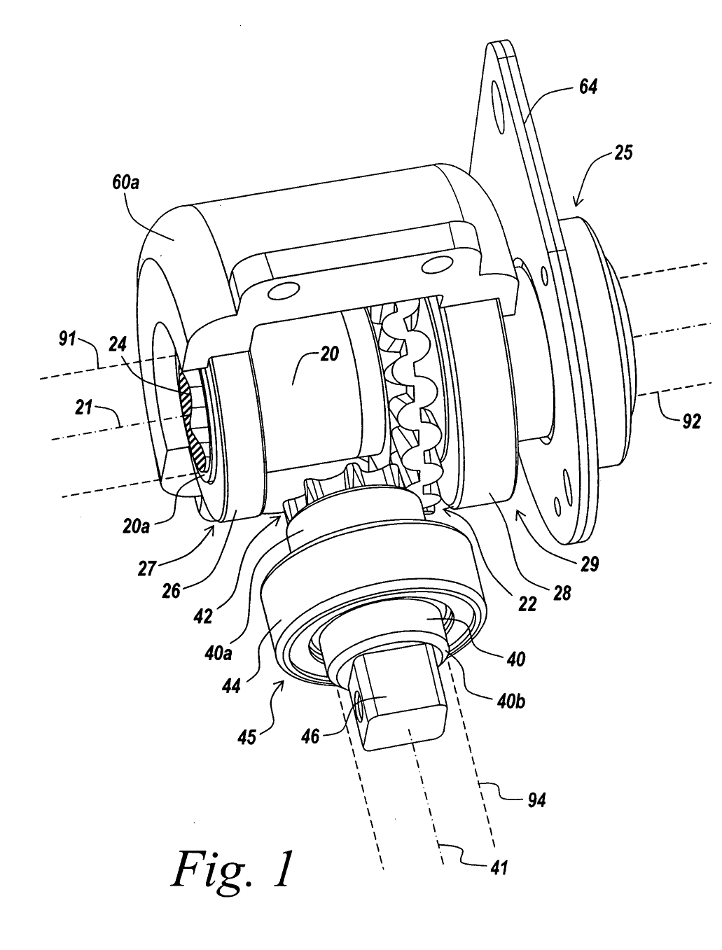

A number of figures encompassed within FIGS. 1 through 4B, wherein like parts are designated by like reference numerals throughout, illustrate example embodiments, or are utilized in describing inventive aspects of an angled drive device that incorporates gears, a driver, and a coupling into a first inner race and a second inner race of suspension bearings.

An embodiment of the present invention provides a reliable, relatively low cost, and compact drive device. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, shape, or type of elements or materials, in a manner still in keeping with the spirit and scope of the present invention.

FIG. 1 depicts an illustrative embodiment of an angled drive device 10, according to aspects of the present invention. The angled drive device 10 incorporates multiple elements into two inner races of support bearings resulting in a lower cost, more compact, and more reliable design. Additionally, two meshing gears, one coupled or integral with each inner race, are designed to reduce manufacturing costs and increase reliability.

The angled drive device 10 includes two inner races, a first inner race 20 and a second inner race 40. The first inner race 20 has a first end 20a and a second end 20b, and includes a driver 24 disposed within the first inner race 20a. The first inner race 20 also includes a first gear 22 disposed between the first end 20a and the second end 20b. The angled drive device also includes three outer races. A first outer race 26 is disposed about the first inner race 20 forming a first support bearing 27. A second outer race 28 is also disposed about the first inner race 20 forming a second support bearing 29. The first gear 22 is positioned between the first support bearing 27 and the second support bearing 29.

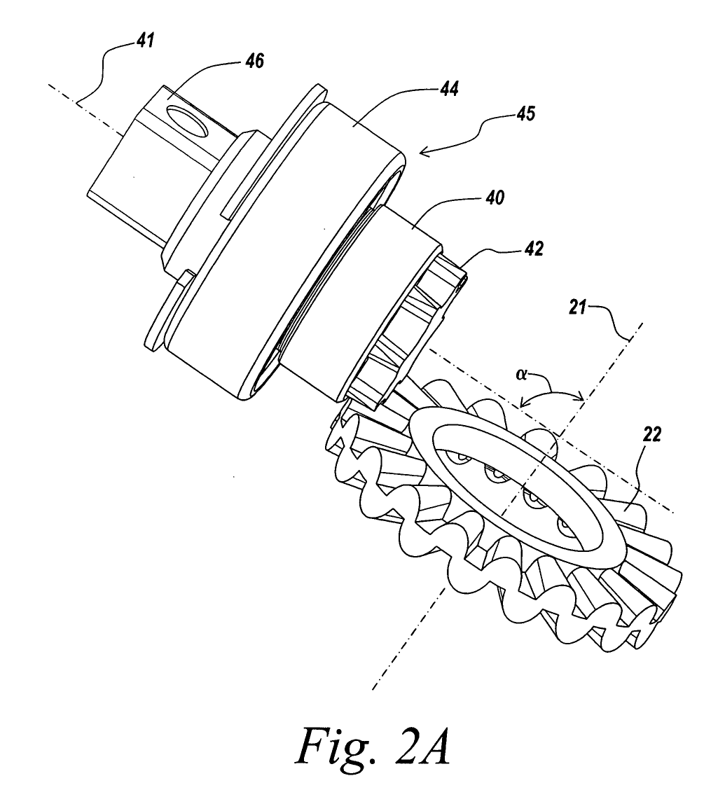

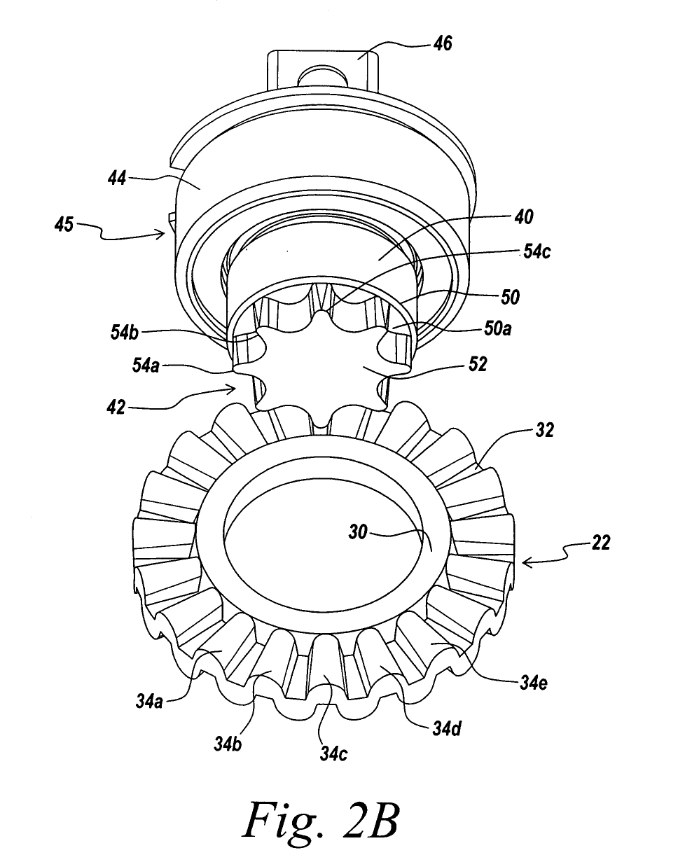

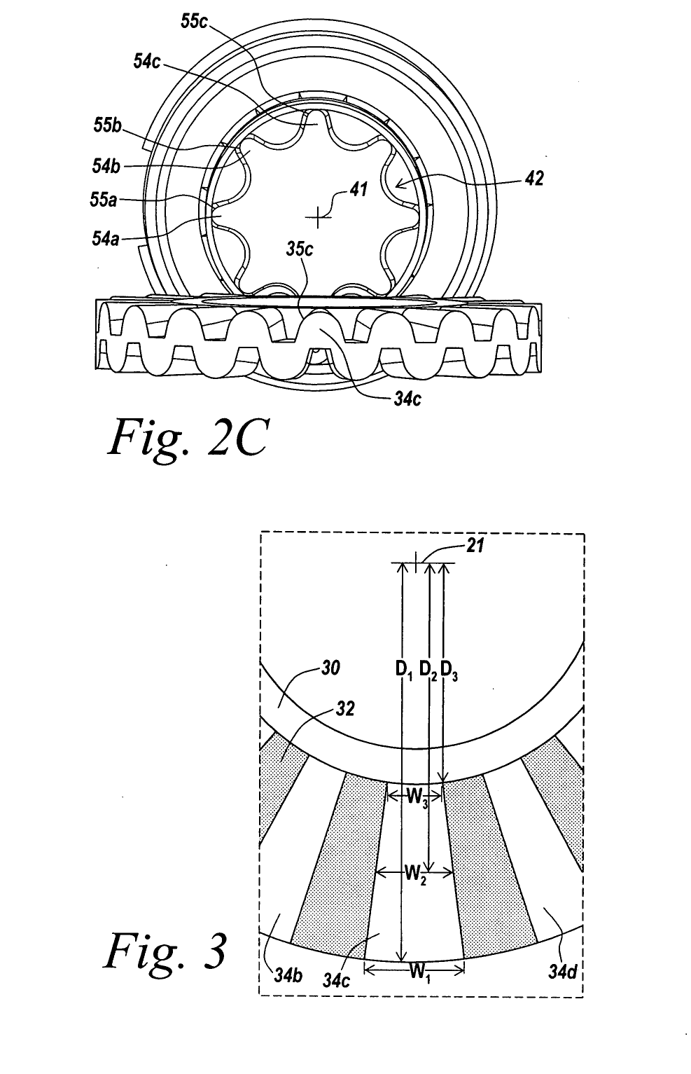

A second inner race 40 has a first end 40a and a second end 40b and includes a second gear 42 coupled with the second inner race 40 at the first end 40a. The second inner race 40 also includes a coupling 46 disposed at the second end 40b. A third outer race 44 of the angled drive device 10 is disposed about the second inner race 40 to form a third support bearing 45. The first gear 22 and the second gear 42 are configured to mesh at a predetermined shaft angle α (see FIG. 2A) to form the angled drive device 10.

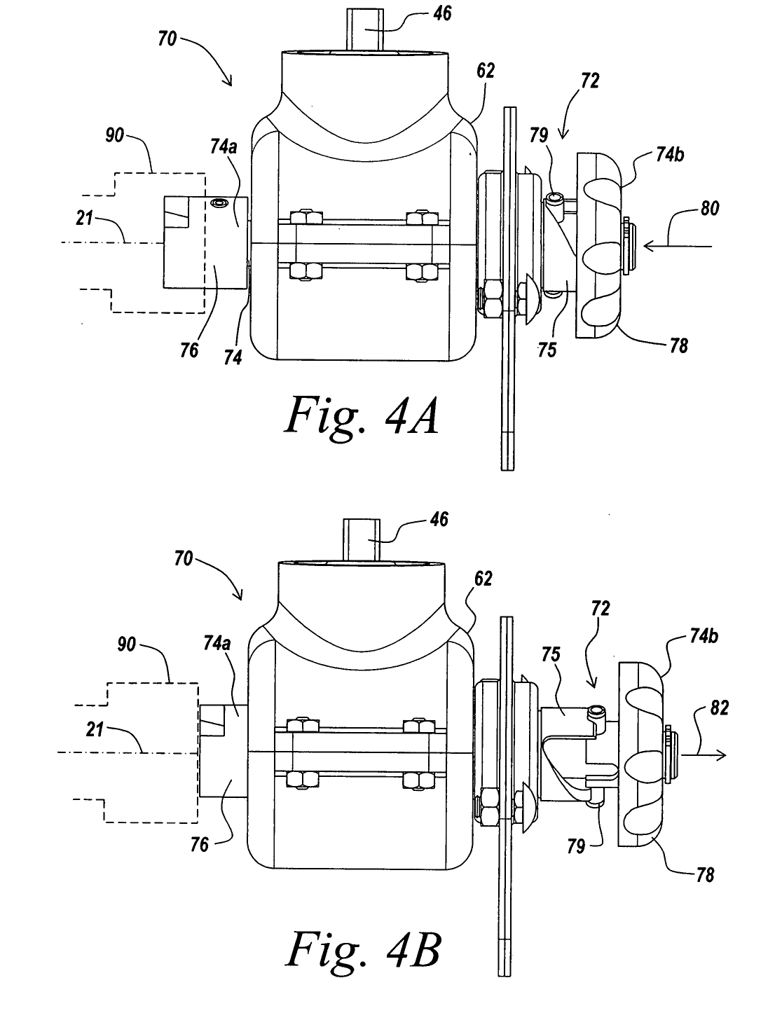

The first inner race 20 and the second inner race 40 can substantially have the form of solid cylinders, or alternatively, either one or both of the inner races can substantially have the form of a cylindrical shell surrounding and affixed to a solid shaft, according to aspects of the present invention. Additionally, one or both of the inner races can be in the form of a solid cylinder with an axial channel as shown in FIGS. 4A and 4B herein. The first inner race 20 and the second inner race 40 can be formed of stainless steel, low carbon steels, powdered metal or any other suitably resilient material known in the art.

The first inner race 20 of the illustrative angled drive device 10 incorporates a driver in the form of a hexagonal cross-section channel 24 within the first inner race 20 and extending along the axis of the first inner race 21. A hexagonal shaft (not shown) can be inserted through the hexagonal cross-section channel 24. Rotation of the hexagonal shaft results in rotation of the hexagonal cross-section channel 24 driving the angled drive device 19. In the illustrative embodiment depicted the driver is a hexagonal cross-section channel 24 extending the length of the first inner race 21; however, one of skill in the art will recognize that the driver can have many different forms including, but not limited to: a channel with a different cross-sectional profile, a shaft disposed within the inner race that couples to a driving mechanism, a coupling disposed at either end of the inner race that couples the inner race with a driving mechanism, a coupling formed in either end of the inner race that couples the inner race with a driving mechanism, or any combination of the aforementioned.

The second inner race 40 of the illustrative angled drive device 10 incorporates a coupling 46 in the form of a square bore shaft coupling, however, the coupling can be any other suitable form of coupling, for example: splines, flexible connectors, etc. The coupling 46 can be formed in the distal end 40b of the second inner race 40, machined into the distal end 40b of fixed to the distal end 40b, or manufactured using any suitable technique known in the art.

The illustrative angled drive device 10 incorporates support bearings 27, 29, 45 in the form of radial bearings, however, the support bearings can be any type of suitable support bearings for rotational shafts, e.g. bushings of various materials. Suitable types of support bearings are reliable, durable, require little maintenance, and can support significant torsional forces.

FIGS. 2A-2C depict only a portion of the exemplary angled drive device 10 illustrated in FIG. 1, so that elements and aspects of the angled drive device 10 can be clearly seen. In FIGS. 2A-2C, the first gear 22, the second inner race 40 including the second gear 42 and the coupling 46, and the third outer race 44 forming the third support bearing 45, are depicted. However, the first inner race 20, the driver 24, and the first outer race 26 and second outer race 28 that form the first support bearing 27 and second support bearing 28, are not shown. FIGS. 2A-2C show the same portion of the exemplary angle drive device 10 from different viewpoints to depict a predetermined shaft angle α, to illustrate different aspects of the structure and design of the first gear 22 and the second gear 42, and to illustrate how the first gear 22 and the second gear 42 mesh.

A predetermined shaft angle α is illustrated in FIG. 2A. The predetermined shaft angled α is formed between an axis 21 (see also FIG. 1) of the first inner race 20 (not shown here), which is also an axis of the first gear 22, and an axis 41 (see also FIG. 1) of the second inner race 40, which is also an axis of the second gear 42. Embodiments of the present invention are directed to angled drive devices, meaning that the axis 21 of the first inner race and the axis 41 of the second inner race 41 are not parallel to each other. As utilized herein, a shaft angle is the predetermined angle α between the axis of the first inner race 21 and the axis of the second inner race 41. The angle α will be referred to as a predetermined shaft angle even though the first inner race 20 and the second inner race 40 do not both incorporate elements referred to as shafts.

If the axis of the first inner race 21 and the axis of the second inner race 41 intersect (they lie on the same plane), then the angle α between them is the angle of intersection. If the axis of the first inner race 21 and the axis of the second inner race 41 do not intersect (they don't lie on the same plane), then the angle α between them is the angle of intersection between the axis of the first inner race 21 and a line parallel to the axis of the second inner race 41 that intersects the axis of the first inner race 21. The intersection of two lines can produce two right (90 degree) angles, or an obtuse (>90 degree) angle and an acute angle (<90 degree). For clarity, the predetermined shaft angle α is defined as either one of the right angles or the acute angle. In other words, the predetermined shaft angle α will be less than or equal to 90 degrees by definition.

As shown in this embodiment, the predetermined shaft angle is substantially 90 degrees, but one of skill in the art will appreciate that embodiments of the present invention could incorporate a predetermined shaft angle between about 45 degrees and about 90 degrees.

FIGS. 2B and 2C illustrate a shape of the first gear 22 and the shape of the second gear 42 according to aspects of the present invention. As shown in FIG. 2B, the first gear 22 has an inner cylindrical ring member 30 and a disc member 32 integral with the inner cylindrical ring member 30. The disc member 32 includes a plurality of tooth protrusions 34a, 34b, 34c etc. In, FIG. 2C, one of the tooth protrusions 34c is shown radially clearly depicting a rounded profile 35c. Each tooth protrusion has a rounded profile, which reduces wear.

FIG. 3 shows an expanded axial view of the first gear 22. A width of a rounded profile of a tooth protrusion 34c at a specific distance from the axis 21 of the first gear (which is also the axis of the first inner race) decreases as a distance from the axis 21 of the first gear decreases. At distance D₁ from the axis 21, a width W₁ of the rounded profile is shown. At distance D₂ from the axis 21, a width W₂ of the rounded profile is relatively smaller than that of width W₁. At distance D₃ from the axis 21, a width D₃ of the rounded profile is relatively smaller than that of width W₂. The decreasing width of the rounded profile with decreasing distance from the axis 21 enables the tooth protrusions 35a, 36b, etc. of the first gear 22 to make line contact when meshing with the second gear 42, thereby reducing wear.

The first gear 22 can be stamped, formed, machined or produced by a combination of the aforementioned methods, according to aspects of the present invention. It can be most economical to produce the exemplary embodiment of the first gear 22 shown by stamping. In the exemplary embodiment shown the first gear 22 is fixed to the first inner race 20. The exemplary embodiment of the first gear 22 shown is in the form of a modified pinion gear, but other suitable types of gears that could be used for the first gear include bevel or spline. Suitable materials for the first gear include steel, other metals, powdered metal, plastic or other sufficiently resilient materials.

As shown in FIG. 2B, the second gear 42 includes a cylindrical base 50 with a first face 50a and a raised gear portion 52 protruding from the first face 50a that is integral with the cylindrical base 50, according to aspects of the present invention. The raised gear portion 52 includes a plurality of teeth 54a, 54b, etc. A profile 55a, 55b, etc. (see also FIG. 2C) of each tooth 54a, 54b, etc. is substantially “U” shaped when viewed axially. The profile of each tooth tapers along an axial profile enabling the second gear 42 to make line contact when meshing with the first gear 22. Line contact is preferable to point contact because line contact results in less wear. In this exemplary embodiment, the second gear 42 is in the form of modified spur gear where the “U” shaped teeth reduce wear. Because all of the raised gear portion 52, including each tooth 54a, 54b, etc. is integral with the cylindrical base 50, each tooth is additionally supported relative to freestanding. However, the present invention does not preclude use of freestanding gear teeth in place of the raised gear portion 52 shown. The second gear 42 can be formed, machined, or both. The entirety of the second gear 42 can be integral with the second inner race 40 as shown. The second gear member 42 can be machined into the first end 40a of the second inner race 40 or formed with the second inner race 40. Alternately, in an embodiment not depicted in this figure, the second gear member 42 can be machined into a shaft or formed with a shaft, and the shaft affixed to the second inner race 40. Although the second gear 42 depicted is in the form of a modified spur gear, one of skill in the art will recognize that the second gear can also take the form of other suitable gear types within the scope of the present invention. Suitable materials for the second gear include steel, other metals, powdered metal, plastic or other sufficiently resilient materials.

FIG. 1 also depicts other aspects of an illustrative embodiment of the present invention. The angled drive device 10 can include a drive housing 60. In this figure, the drive housing 60 is formed of multiple parts 60a, 60b (not shown), one of which 60b is removed for illustrative purposes. A complete drive housing 62 is illustrated in FIGS. 4A and 4B. The drive housing 60 protects the gears 30, 50 and prevents material from coming between the gears and interfering with operation of the drive. Additionally, the drive housing 60 provides stability and support for the support bearings 27, 29, 45. The angled drive device 10 can include a flange mount 64 or any other suitable mounting mechanism for securing the angled drive device 10 to a system. The mount 64 can be attached to the drive housing 60, or the flange mount 64 can be free floating with respect to the drive housing 60. The angled drive device 10 can also include a fourth support bearing 25. The fourth support bearing can be attached to the first inner race 20 and the flange mount 64.

FIGS. 4A and 4B diagrammatically illustrate another embodiment of an angled drive device 70 of the present invention that includes a locking engagement mechanism 72, according to aspects of the present invention. A locking engagement mechanism 72 allows an angled drive device 70 to be engaged and disengaged from a portion of a drive system 90. A locking engagement mechanism 72 is useful in a multi-row planter where the number of rows planted simultaneously may need to be varied for different planting circumstances. An angled drive device for each row of the multi-row planter can be individually engaged or disengaged to vary the number of rows being planted simultaneously. In this embodiment, the driver is a round shaft 74 with a first end 74a and a second end 74b, that extends along the axis 21 of the first inner race. The shaft 74 can slide in both directions along the axis 21 of the first inner race. A drive coupling 76 is disposed at the first end 74a of the shaft and a handle 78 is disposed at the second end 74b of the shaft. A cross pin 79 is disposed at the second end 74b of the shaft, coupling the shaft 74 with the first inner race 75. In FIG. 4A the handle 78 is in its locked position and shifted in the direction of arrow 80 toward the drive housing 62. Because the driver coupling 76 is connected with the handle 78 through the shaft 74, the driver coupling 76 is extended from the drive housing 62 in the direction of arrow 80. In this position, the driver coupling 76 is engaged with the driver system 90.

In FIG. 4B the handle 78 has been turned counter-clockwise to its unlocked position and shifted in the direction of arrow 82 away from the drive housing 62. Shifting the handle 78 in the direction of arrow 82 results in the driver coupling 76 shifting in the direction 82 and retracting toward the drive housing 62. This shift causes the driver coupling 76 to disengage from the drive system 90. Although this illustrative embodiment depicts one particular type of locking engagement mechanism 72, many different locking engagement mechanisms known in the art can be incorporated into an angled device driver of the present invention.

In operation, an angled drive device 10 of the present invention (depicted in FIG. 1) transforms rotational motion about a first axis into rotational motion about a second nonparallel axis. A driver in the form of a hexagonal cross-section channel 24 couples the angled drive device 10 to a system 92. Rotational motion of a portion of the system 92 (in this embodiment a hexagonal shaft) about an axis 21 of the first inner race causes rotational motion of the hexagonal cross-section channel 24 coupled to the system 92. Because the hexagonal cross-section channel 24 is disposed within the first inner race 20, rotational motion of the hexagonal cross-section channel 24 causes rotational motion of the first inner race 20. Because the first gear 22 is coupled to the first inner race 20, rotational motion of the first inner race causes rotational motion of the first gear 22. The driver in the form of the hexagonal cross-section channel 24, the first inner race 20 and the first gear 22 rotate in unison driven by the rotational motion of the portion of the system 92 coupled to the hexagonal cross-section channel 24.

The first inner race is supported by a first support bearing 27 and a second support bearing 29. The first support bearing 27 and the second support bearing 29 provide low friction support and stability for the first inner race 20 as it rotates. The mounting flange 64 can be used to mount the angled drive device 10 and to provide additional stability for the first inner race 20 as it rotates.

During rotation, the first gear meshes 22 with the second gear 42 making line contact with the second gear 42 (see also FIGS. 2A-2C). Rounded profiles of tooth protrusions 34a, 34b, etc. of the first gear 22 and “U” shaped profiles of teeth 54a, 54b, etc. of the second gear 42 are shaped to reduce wear and to enable the first gear 22 and the second gear 42 make line contact when meshing.

Rotation of the first gear 22 about the axis 21 of the first inner race 20 is transformed into rotation of the second gear 42 about the axis 41 of the second inner race 40 through the meshing of the gears. Because the second gear 42 is coupled with the second inner race 40, rotation of the second gear 42 causes rotation of the second inner race 40. As the second inner race 40 rotates, a third support bearing 45 provides low friction support and stability to the second inner race 40. Rotation of the second inner race 40 results in rotation of a coupling 46 disposed at a distal end 40b of the second inner race 40. The coupling 46 is connected to an element 94 of a system to transfer rotational energy about the axis 41 of the second inner race 40 from the angled drive device 10 to the element 94. As described above, in operation the angled drive device 10 is driven by the portion of a system 92 that rotates about the axis 21 of the first inner race 20 and drives the element 94 of a system to rotate about the axis 41 of the second inner race. One of ordinary skill in the art will recognize that alternatively, the angled drive device 10 can be driven by the element 94 of a system rotating about the axis 41 of the second inner race 40 and drive the portion of a system 92 to rotate about the axis 21 of the first inner race.

As illustrated in FIGS. 4A and 4B, another illustrative angled drive device 70 can include a housing 62. The housing 62 provides support and stability during operation by supporting a first outer race 26 of the first support bearing 27, a second outer race 28 of the second support bearing 29, and a third outer race 44 of the third support bearing 45. Additionally, during operation the housing 62 prevents debris from entering the support bearings 27, 29, 45 and from coming between the meshing gears 22, 42.

As also illustrated in FIGS. 4A and 4B, another embodiment of the angled drive device 70 incorporates a locking engagement mechanism 72 enabling the angled drive device 70 to be engaged and disengaged from a drive system 90. Initially, the angled drive device 70 is engaged with the drive system 90. The drive system 90 couples to a drive coupling 76 of the angled drive device 70. Rotation of a portion of the drive system 90 about the axis 21 results in rotation of the drive coupling 76 attached to the first end 74a of the round shaft 74. Rotation of the shaft 74 disposed within and coupled to the first inner race 20 causes rotation of the first inner race 20. When the drive system 90 is not rotating, the angled drive device 70 can be disengaged from the drive system 90. To disengage the angled drive device 70, the handle 78 is rotated counter-clockwise. Counter-clockwise rotation of the handle 78 results in the shaft 74 shifting in the direction of arrow 82. Shifting the shaft 74 causes the drive coupling 76 to shift in the direction of arrow 82. The shift of the drive coupling 76 disengages the angled drive device 70 from the drive system 90.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover generic and specific features of the invention described herein, and all statements of the scope of the invention which, as a matter of language, might be said to fall there between.

What is claimed is:

1. An angled drive device, comprising:
a first inner race having a first and a second end, the first inner race further comprising:
a driver disposed within the first inner race; and
a first gear disposed between the first and second ends of the first inner race;
a first outer race disposed about the first inner race to form a first support bearing;
a second outer race disposed about the first inner race to form a second support bearing, the first gear positioned between the first and second support bearings;
a second inner race having a first end and a second end, the second inner race further comprising:
a second gear coupled with the second inner race at the first end of the second inner race; and
a coupling disposed at the second end of the second inner race; and
a third outer race disposed about the second inner race to form a third support bearing;
wherein the first gear and the second gear are configured to mesh at a predetermined shaft angle to form the angled drive device.

2. The angled drive device of claim 1, wherein the second gear is formed integral with the second inner race.

3. The angled drive device of claim 1, further comprising a shaft coupled with the second inner race and coupled with the second gear.

4. The angled drive device of claim 3, wherein the second gear is formed integral with the shaft.

5. The angled drive device of claim 1, wherein the predetermined shaft angle is between about 45 degrees and about 90 degrees.

6. The angled drive device of claim 1, wherein the predetermined shaft angle is substantially 90 degrees.

7. The angled drive device of claim 1, wherein the first gear comprises:
an inner cylindrical ring member; and
a disc member integral with the inner cylindrical ring member and having a plurality of tooth protrusions;
wherein each of the plurality of tooth protrusions has a rounded profile when viewed radially;
wherein a width of the rounded profile of each tooth protrusion becomes smaller as a distance from an axis of the first gear decreases; and
wherein a shape of each tooth protrusion and the width of the rounded profile of each tooth protrusion enable line contact when meshing.

8. The angled drive device of claim 1, wherein the first gear is a formed gear, a stamped gear or a machined gear.

9. The angled drive device of claim 1, the second gear comprising:
a cylindrical base with a first face; and
a raised gear portion protruding from the first face of the cylindrical base and integral with the cylindrical base, the raised gear portion having a plurality of teeth, wherein a profile of each tooth is substantially “U” shaped when viewed axially, and wherein each tooth tapers along an axial profile enabling line contact when meshing.

10. The angled drive device of claim 1, wherein the second gear is a form of a spur gear.

11. The angled drive device of claim 1, further comprising a drive housing coupled with the first support bearing, the second support bearing, and the third support bearing.

12. The angled drive device of claim 1, further comprising a mounting flange coupled with the first inner race.

13. The angled drive device of claim 1, further comprising a locking engagement mechanism coupled with the first inner race, wherein the locking engagement mechanism extends a coupling to rotationally couple the angled drive device to a system and retracts a coupling to disengage the angled drive device from the system.
